(19) United States
(12) Patent Application Publication
(10) Pub. No.: US 2026/0338124 A1
(43) Pub. Date: Oct. 29, 2026

(54) CONTROLLER FOR INTERNAL COMBUSTION ENGINE

(71) Applicant: Mitsubishi Electric Mobility Corporation, Tokyo (JP)

(72) Inventors: Taiga TANAKA, Tokyo (JP); Takuma KUSAGAKI, Tokyo (JP); Nobuyoshi TOMOMATSU, Tokyo (JP); Tatsuo FUJIMOTO, Tokyo (JP); Kenichi YAMAGATA, Tokyo (JP); Hiroki MANABE, Tokyo (JP); Kazuhiro NISHIWAKI, Tokyo (JP)

(73) Assignee: Mitsubishi Electric Mobility Corporation, Tokyo (JP)

(21) Appl. No.: 19/111,453

(22) PCT Filed: Nov. 15, 2022
(86) PCT No.: PCT/JP2022/042329

§ 371 Date: Mar. 13, 2025

(51) Int. Cl. F02D 41/00; F02D 41/24

(52) U.S. Cl. CPC F02D 41/0002; F02D 41/009; F02D 41/0097; F02D 41/2441; F02D 2200/1004; F02D 2200/101

(57) ABSTRACT

To provide a controller for an internal combustion engine which learns the variation in the output torque of the internal combustion engine based on the operating state with good accuracy, and controls so that the output torque approaches the target torque. A controller for an internal combustion engine calculates an estimation torque based on an angular acceleration; learns a deviation between the estimation torque and a reference value of estimation torque, as a torque error learning value; calculates a target throttle opening degree such that an output torque considering the torque error learning value approaches the target torque, based on the target torque, the present rotational speed, and the torque error learning value, using throttle torque characteristic data; and controls a throttle opening degree based on the target throttle opening degree.

### TECHNICAL FIELD

The present disclosure relates to a controller for an internal combustion engine.

### BACKGROUND ART

The controller for the internal combustion engine of patent document 1 controls the output torque of the internal combustion engine, based on the map data representing the relation between the output torque, and the control parameters, such as the intake air amount and the fuel injection amount, which are the operating states affecting the output torque. The technology of patent document 1 learns the difference between the output torque of the internal combustion engine estimated based on the current of the generator generated by the output torque of the internal combustion engine, and the required torque; and corrects the map data based on the difference so that the output torque coincides with the required torque.

### CITATION LIST

### Patent Literature

Patent document 1: JP 2009-23578 A

### SUMMARY OF INVENTION

### Technical Problem

The technology of patent document 1 estimates the output torque of the internal combustion engine based on the current of the generator, and learns the variation in the output torque caused by the individual difference and the aging change. However, since there is variation also in the characteristic of the generator, and the generator generated by the output torque of the internal combustion engine is required, the operating region where the learning is possible and the equipment configuration are limited.

Then, the purpose of the present disclosure is to provide a controller for an internal combustion engine which learns the variation in the output torque of the internal combustion engine caused by the individual difference and the aging change of the internal combustion engine, based on the operating state of the internal combustion engine with good accuracy, suppresses the variation in the output torque of the internal combustion engine using the learning result, and controls so that the output torque approaches the target torque.

### Solution to Problem

A first controller for an internal combustion engine of the present disclosure, including:
a rotation information detection unit that detects a rotational speed and an angular acceleration of a crankshaft of the internal combustion engine;
an estimation torque calculation unit that calculates an estimation torque which is an estimated torque of the crankshaft, based on the angular acceleration;
a learning value calculation unit that learns a deviation between the estimation torque and a preliminarily set reference value of estimation torque, as a torque error learning value;
a torque control unit that, by using a throttle torque characteristic data in which a relation between at least an output torque of the internal combustion engine, the rotational speed, and a throttle opening degree of the internal combustion engine is preliminarily set, calculates a target throttle opening degree such that the output torque considering the torque error learning value approaches the target torque, based on a target torque of the internal combustion engine, the present rotational speed, and the torque error learning value; and
a throttle control unit that controls the throttle opening degree, based on the target throttle opening degree.

A second controller for an internal combustion engine of the present disclosure, including:
a rotation information detection unit that detects a rotational speed and an angular acceleration of a crankshaft of the internal combustion engine;
an estimation torque calculation unit that calculates an estimation torque which is an estimated torque of the crankshaft, based on the angular acceleration;
a learning value calculation unit that learns a deviation between the estimation torque and a preliminarily set reference value of estimation torque, as a torque error learning value;
a second estimation torque calculation unit that, by referring to a torque characteristic data for second estimation torque in which a relation between an operating state for torque characteristic data including at least one or more of a throttle opening degree of the internal combustion engine, a cylinder internal intake air amount, a fuel injection amount, and the rotational speed, and a second estimation torque as an output torque of the internal combustion engine is preliminarily set, calculates a second estimation torque corresponding to the present operating state for torque characteristic data;
a second estimation torque correction unit that calculates a second estimation torque after correction by correcting the second estimation torque with the torque error learning value;
a torque control unit that, by using a throttle torque characteristic data in which a relation between at least the output torque, the rotational speed, and the throttle opening degree is preliminarily set, calculates a target throttle opening degree such that the second estimation torque after correction approaches a target torque of the internal combustion engine, based on the target torque, the present rotational speed, and the second estimation torque after correction; and
a throttle control unit that controls the throttle opening degree, based on the target throttle opening degree.

### Advantage of Invention

According to the first and second controllers for the internal combustion engine of the present disclosure, by comparing the estimation torque calculated based on the actually detected angular acceleration with the reference value of estimation torque, a torque variation caused by the individual variation, the aging change (engine deterioration), or the like of the internal combustion engine can be learned as the torque error learning value. Then, using the throttle torque characteristic data, based on the target torque of the internal combustion engine, the present rotational speed, and the torque error learning value or the second estimation torque after correction corrected by the torque error learning value, the target throttle opening degree such that the output torque considering the torque error learning value approaches the target torque, or the target throttle opening degree such that the second estimation torque after correction approaches the target torque is calculated. Accordingly, the torque variation caused by the individual variation, the aging change (engine deterioration), or the like of the internal combustion engine can be suppressed, and the output torque of the internal combustion engine can be brought close to the target torque.

### BRIEF DESCRIPTION OF THE DRAWINGS

FIG. 1 is a schematic configuration diagram of the controller for the internal combustion engine according to Embodiment 1;

FIG. 2 is a block diagram of the controller for the internal combustion engine according to Embodiment 1;

FIG. 3 is a hardware configuration diagram of the controller for the internal combustion engine according to Embodiment 1;

FIG. 4 is a time chart explaining the processing of the rotation information detection unit according to Embodiment 1;

FIG. 5 is a figure explaining the relation between each cylinder and each stroke according to Embodiment 1;

FIG. 6 is a figure explaining the target torque setting data according to Embodiment 1;

FIG. 7 is a figure explaining the calculation of the maximum value of the angular acceleration of each cylinder according to Embodiment 1;

FIG. 8 is a block diagram of the learning value calculation unit according to Embodiment 1;

FIG. 9 is a figure explaining the torque characteristic data for reference value according to Embodiment 1;

FIG. 10 is a figure explaining the throttle torque characteristic data according to Embodiment 1;

FIG. 11 is a block diagram of the torque control unit according to Embodiment 1;

FIG. 12 is a block diagram explaining an example of the target torque correction unit according to Embodiment 1;

FIG. 13 is a block diagram of the controller for the internal combustion engine according to Embodiment 2;

FIG. 14 is a block diagram of the torque control unit according to Embodiment 2;

FIG. 15 is a block diagram of the controller for the internal combustion engine according to Embodiment 3;

FIG. 16 is a block diagram of the learning value calculation unit according to Embodiment 3;

FIG. 17 is a time chart explaining the error learning according to Embodiment 3;

FIG. 18 is a time chart explaining the error learning according to Embodiment 3;

FIG. 19 is a block diagram of the controller for the internal combustion engine according to Embodiment 4; and

FIG. 20 is a figure explaining the torque characteristic data for second estimation torque according to Embodiment 4.

### DETAILED DESCRIPTION OF THE EMBODIMENTS

### 1. Embodiment 1

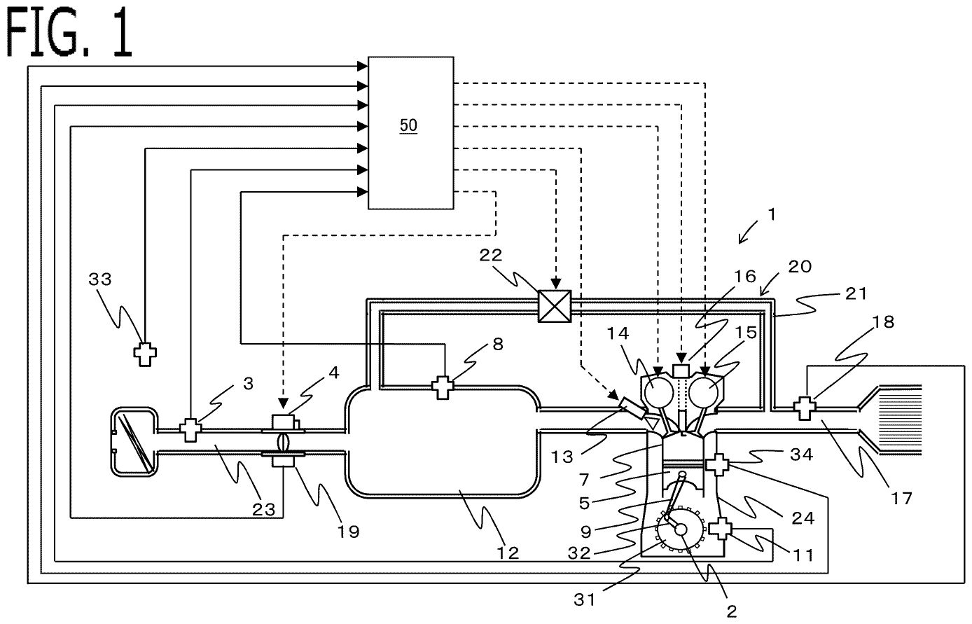

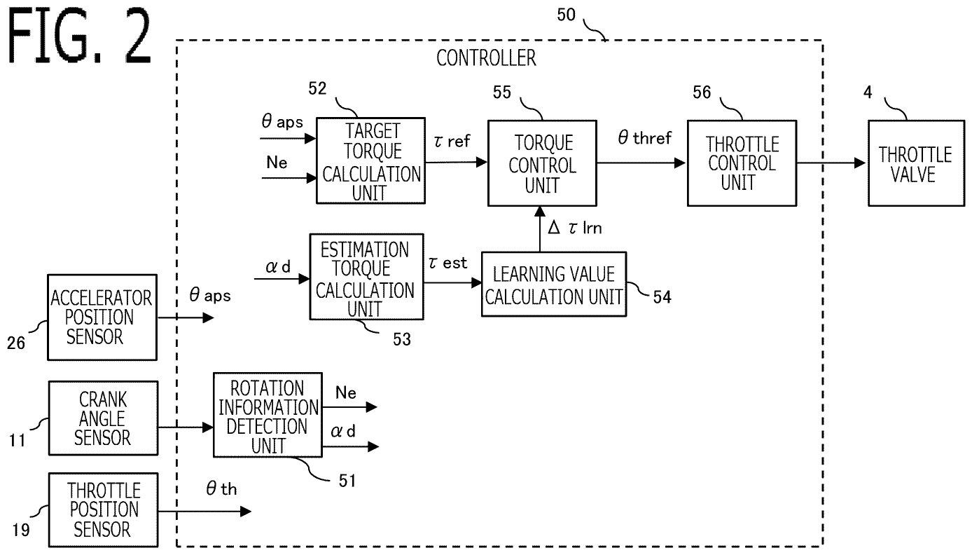

A controller 50 for an internal combustion engine (hereinafter, referred to simply as the controller 50) according to Embodiment 1 will be explained with reference to the drawings. FIG. 1 is a schematic configuration diagram of the internal combustion engine 1 and the controller 50; and FIG. 2 is a block diagram of the controller 50 according to Embodiment 1.

### 1-1. Configuration of Internal Combustion Engine 1

The configuration of the internal combustion engine 1 will be explained. As shown in FIG. 1, the internal combustion engine 1 is provided with a combustion chamber 7 (hereinafter, referred to also as a cylinder 7) in which a fuel-air mixture is combusted. The internal combustion engine 1 is provided with an intake pipe 23 for supplying air to the combustion chamber 7 and an exhaust pipe 17 for discharging exhaust gas from the combustion chamber 7. The internal combustion engine 1 is a gasoline engine. The internal combustion engine 1 is provided with a throttle valve 4 which opens and closes intake pipe 23. The throttle valve 4 is an electronically controlled throttle valve which is opening/closing-driven by an electric motor controlled by controller 50. A throttle position sensor 19 which outputs an electric signal according to the opening degree of the throttle valve 4 is provided in the throttle valve 4.

An air flow sensor 3 which outputs an electric signal according to an intake air amount taken into the intake pipe 23 is provided in the intake pipe 23 on the upstream side of throttle valve 4. The internal combustion engine 1 is provided with an exhaust gas recirculation apparatus 20. The exhaust gas recirculation apparatus 20 is provided with an EGR passage 21 which recirculates the exhaust gas from the exhaust pipe 17 to the intake manifold 12, and an EGR valve 22 which opens and closes the EGR passage 21. The intake manifold 12 is a part of the intake pipe 23 on the downstream side of the throttle valve 4. The EGR valve 22 is an electronic controlled EGR valve which is opening/closing-driven by an electric motor controlled by controller 50. An air-fuel ratio sensor 18 which outputs an electric signal according to an air-fuel ratio of exhaust gas in the exhaust pipe 17 is provided in the exhaust pipe 17.

A gas pressure sensor 8 which outputs an electric signal according to a pressure in the intake manifold 12 is provided in the intake manifold 12. An injector 13 for injecting a fuel is provided on the downstream side part of the intake manifold 12. The injector 13 may be provided so as to inject a fuel directly into the cylinder 7. An atmospheric pressure sensor 33 which outputs an electric signal according to an atmospheric pressure is provided in the internal combustion engine 1. A water temperature sensor 34 which detects a cooling water temperature is provided in the internal combustion engine 1.

An ignition plug for igniting a fuel-air mixture and an ignition coil 16 for supplying ignition energy to the ignition plug are provided on the top of the combustion chamber 7. At the top of the combustion chamber 7, an intake valve 14 for adjusting an intake air amount to be taken from the intake pipe 23 into the combustion chamber 7 and an exhaust valve 15 for adjusting an exhaust gas amount to be exhausted from the combustion chamber 7 to the exhaust pipe 17 are provided. The intake valve 14 is provided with an intake variable valve timing mechanism for varying the opening and closing timing thereof. The exhaust valve 15 is provided with an exhaust variable valve timing mechanism for varying the opening and closing timing thereof. Each of the variable valve timing mechanisms 14, 15 is provided with an electric actuator.

The internal combustion engine 1 is provided with a plurality of combustion chambers 7 (in this example, four). A piston 5 is provided in each combustion chamber 7. The piston 5 of each combustion chamber 7 is connected to a crankshaft 2 via a connecting rod 9 and a crank 32. The crankshaft 2 is rotated by the reciprocating movement of the piston 5. A combustion gas pressure generated in each combustion chamber 7 presses the top face of the piston 5, and rotates the crankshaft 2 via the connecting rod 9 and the crank 32. The crankshaft 2 is connected with a power transfer mechanism which transmits driving force to a wheel, a generator and the like. The power transfer mechanism is composed of a transmission and the like.

The internal combustion engine 1 is provided with a rotor 31 which rotates integrally with the crankshaft 2. A plurality of teeth are provided in the rotor 31 at a plurality of preliminarily set crank angles. In the present embodiment, the teeth of the rotor 31 are arranged at intervals of 20 degrees. The teeth of the rotor 31 are provided with a chipped tooth part where a part of teeth is chipped. The internal combustion engine 1 is provided with a crank angle sensor 11 which is fixed to an engine block 24 and detects the tooth of the rotor 31.

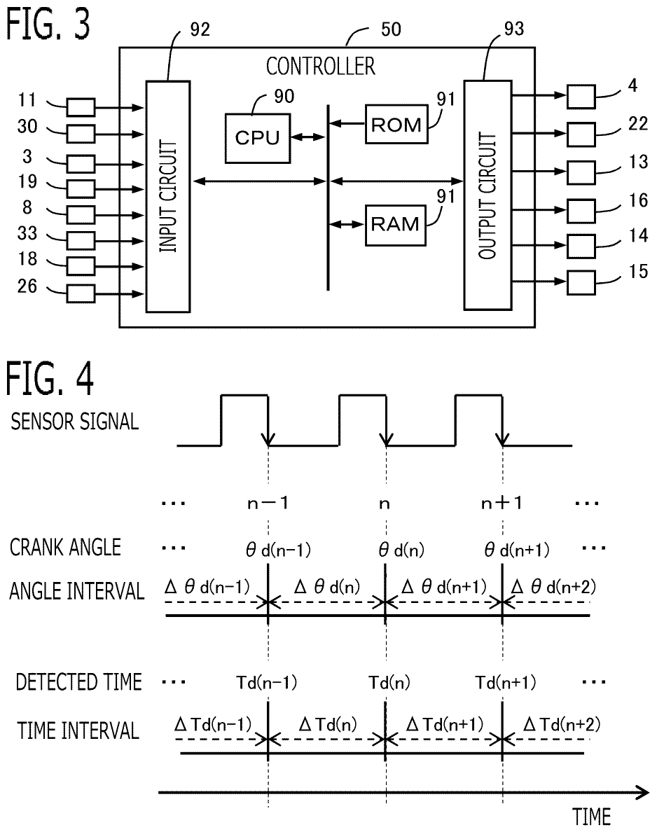

The internal combustion engine 1 is provided with a cam shaft connected with the crankshaft via a chain. The cam shaft opens and closes the intake valve 14 and the exhaust valve 15. During the crankshaft 2 rotates twice, the cam shaft rotates once. The internal combustion engine 1 is provided with a rotor for cam which rotates integrally with the cam shaft. A plurality of teeth are provided in the rotor for cam at a plurality of preliminarily set cam shaft angles. The internal combustion engine 1 is provided with a cam angle sensor 30 which is fixed to the engine block 24 and detects the tooth of the rotor for cam (refer to FIG. 3).

Based on two kinds of output signals of the crank angle sensor 11 and the cam angle sensor 30, the controller 50 detects the crank angle on the basis of the top dead center (TDC) of each piston 5 and determines the stroke of each combustion chamber 7. The internal combustion engine 1 is a 4-stroke engine which has an intake stroke, a compression stroke, a combustion stroke, and an exhaust stroke.

Each of the crank angle sensor 11 and the cam angle sensor 30 outputs an electric signal according to a change of the distance between each sensor and tooth by rotation of the crankshaft 2. The output signal of each angle sensor 11, 30 becomes a rectangular wave that a signal turns on or off when the distance between sensor and tooth is near or when the distance is far. An electromagnetic pickup type sensor is used for each angle sensor 11, 30, for example.

The configuration of the internal combustion engine may not be limited to the configuration explained using FIG. 1, but various kinds of internal combustion engines may be used.

### 1-2. Configuration of Controller 50

Next, the controller 50 will be explained. As shown in FIG. 2, the controller 50 is provided with processing units such as a rotation information detection unit 51, a target torque calculation unit 52, an estimation torque calculation unit 53, a learning value calculation unit 54, a torque control unit 55, and a throttle control unit 56. The respective processing units 51 to 56 of the controller 50 are realized by processing circuits provided in the controller 50. Specifically, as shown in FIG. 3, the controller 50 is provided with, as a processing circuit, an arithmetic processor (computer) 90 such as a CPU (Central Processing Unit), storage apparatuses 91 connected to the arithmetic processor 90 via a bus or other signal line, an input circuit 92 which inputs external signals to the arithmetic processor 90, an output circuit 93 which outputs signals from the arithmetic processor 90 to the outside, and the like.

As the arithmetic processor 90, ASIC (Application Specific Integrated Circuit), IC (Integrated Circuit), DSP (Digital Signal Processor), FPGA (Field Programmable Gate Array), various kinds of logical circuits, various kinds of signal processing circuits, and the like may be provided. As the arithmetic processor 90, a plurality of the same type ones or the different type ones may be provided, and each processing may be shared and executed.

As the storage apparatus 91, volatile and nonvolatile storage apparatuses, such as RAM (Random Access Memory), ROM (Read Only Memory), and EEPROM (Electrically Erasable Programmable ROM), are provided. The input circuit 92 is connected with various kinds of sensors and switches and is provided with an A/D converter and the like for inputting output signals from the sensors and the switches to the arithmetic processor 90. The output circuit 93 is connected with electric loads and is provided with a driving circuit and the like for outputting a control signal from the arithmetic processor 90.

Then, the arithmetic processor 90 runs software items (programs) stored in the storage apparatus 91 such as ROM and EEPROM, and collaborates with other hardware devices in the controller 50, such as the storage apparatus 91, the input circuit 92, and the output circuit 93, so that the respective functions of the processing units 51 to 56 provided in the controller 50 are realized. Setting data, such as the target torque setting data, the torque characteristic data for reference value, the throttle torque characteristic data, the correction coefficient setting data, the inertia moment Icrk, and the load torque τload, used by the processing units 51 to 56, are stored in the storage apparatus 91, such as ROM and EEPROM. Data of calculation values and detection values, such as the rotational speed Ne, the angular speed ωd, the angular acceleration αd, the maximum value αmax of angular acceleration, the estimation torque test, the reference value of estimation torque τestref, the torque error learning value Δτlrn, the target throttle opening degree for reference value θthref0, the target torque after correction τrefcrr, the correction coefficient Kτ, the target torque τref, the torque correction value τcom, and the target throttle opening degree θthref, calculated by the processing units 51 to 56, are stored in the rewritable storage apparatus 91 such as RAM.

In the present embodiment, the input circuit 92 is connected with the crank angle sensor 11, the cam angle sensor 30, the water temperature sensor 34, the air flow sensor 3, the throttle position sensor 19, the gas pressure sensor 8, the atmospheric pressure sensor 33, the air fuel ratio sensor 18, an accelerator position sensor 26, and the like. The output circuit 93 is connected with the throttle valve 4 (electric motor), the EGR valve 22 (electric motor), the injector 13, the ignition coil 16, the intake-air variable valve timing mechanism 14, the exhaust-gas variable valve timing mechanism 15, and the like. The controller 50 is connected with various kinds of unillustrated sensors, switches, actuators, and the like. The controller 50 detects operating conditions of the internal combustion engine 1, such as a throttle opening degree θth, a cylinder internal intake air amount, a pressure in the intake manifold, an atmospheric pressure, an air-fuel ratio, and an accelerator opening degree θaps, based on the output signals of various sensors.

As a basic control, the controller 50 calculates a fuel injection amount, an ignition timing, and the like, based on the inputted output signals and the like from the various kinds of sensors, and then drives and controls the injector 13, the ignition coil 16, and the like. And, the controller 50 calculates a target opening degree of the EGR valve 22 based on the inputted output signals and the like from the various kinds of sensors and then drives and controls the electric motor of the EGR valve 22. The controller 50 calculates a target opening and closing timing of the intake valve and a target opening and closing timing of the exhaust valve based on the output signals of the various sensors, and drives and controls the intake and the exhaust variable valve timing mechanisms 14, 15 based on each target opening and closing timing.

### 1-2-1. Rotation Information Detection Unit 51

The rotation information detection unit 51 detects a rotational speed Ne and an angular acceleration αd of the crankshaft of the internal combustion engine. In the present embodiment, the rotation information detection unit 51 detects a crank angle θd based on the output signal of the crank angle sensor 11, and calculates the angular speed ωd which is a time change rate of the detected crank angle θd, and the angular acceleration αd which is a time change rate of the angular speed ωd. The rotation information detection unit 51 detects the rotational speed Ne of the crankshaft, based on the output signal of the crank angle sensor 11. The rotational speed Ne corresponds to the angular speed ωd, but in the present embodiment, it is an average speed during the stroke period.

In the present embodiment, as shown in FIG. 4, the rotation information detection unit 51 detects the crank angle θd based on the output signal of the crank angle sensor 11, and detects a detection time Td when the crank angle θd is detected. Then, the rotation information detection unit 51 calculates an angle interval Δθd and a time interval ΔTd corresponding to the interval between the detected angles θd, based on the detected angle θd which is the detected crank angle θd, and the detection time Td.

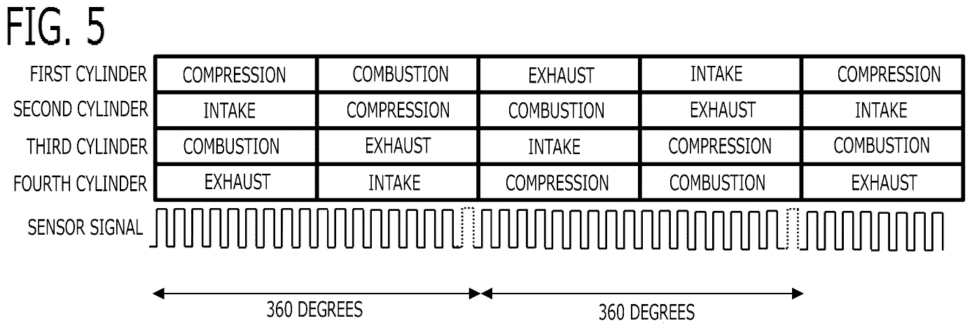

For example, the rotation information detection unit 51 determines the crank angle θd when the falling edge (or rising edge) of the output signal (rectangular wave) of the crank angle sensor 11 is detected. The rotation information detection unit 51 detects the crank angle θd on the basis of the top dead center (TDC) of the piston of the first cylinder and determines the stroke of each cylinder 7, based on two kinds of output signals of the crank angle sensor 11 and the cam angle sensor 30, using a well-known method. FIG. 5 shows strokes of the first cylinder to the fourth cylinder.

<Calculation of Angular Speed ωd and Angular Acceleration αd>

The rotation information detection unit 51 calculates the angular speed ωd, based on each crank angle θd, and the detection time Td when each crank angle θd is detected. For example, as shown in the next equation, the rotation information detection unit 51 calculates the angular speed ωd (n) at the present detected angle, based on the angle interval Δθd (n) between the crank angle θd (n) detected this time and the crank angle θd (n−1) detected the previous time, and the time interval ΔTd (n) between the present detection time Td (n) and the previous detection time Td (n−1). Various well-known methods other than this may be used for the calculation of the angular speed ωd.

$$\begin{matrix}[ Math . 1 ] & \\ Δθ d ( n ) = θ d ( n ) - θ d ( n - 1 ) \\ Δ Td ( n ) = Td ( n ) - Td ( n - 1 ) \\ ω d ( n ) = \frac{Δθ d ( n )}{Δ Td ( n )} & ( 1 )\end{matrix}$$

The rotation information detection unit 51 calculates the angular acceleration αd based on the angular speed ωd. For example, as shown in the next equation, the rotation information detection unit 51 calculates the angular acceleration at the present detected angle αd (n), based on the angular speed ωd (n) calculated at the present detected angle, the angular speed ωd (n−1) calculated at the previous detected angle, and the time interval ΔTd (n) at the present detected angle. Various well-known methods other than this may be used for the calculation of the angular acceleration αd.

$$\begin{matrix}[ Math . 2 ] & \\ α d ( n ) = \frac{ω d ( n ) - ω d ( n - 1 )}{Δ Td ( n )} & ( 2 )\end{matrix}$$

### 1-2-2. Target Torque Calculation Unit 52

The target torque calculation unit 52 calculates an output torque τ of the internal combustion engine 1 requested by the driver, as a target torque τref, based on the accelerator opening degree θaps detected based on the output signal of the accelerator position sensor 26, the rotational speed Ne and the like.

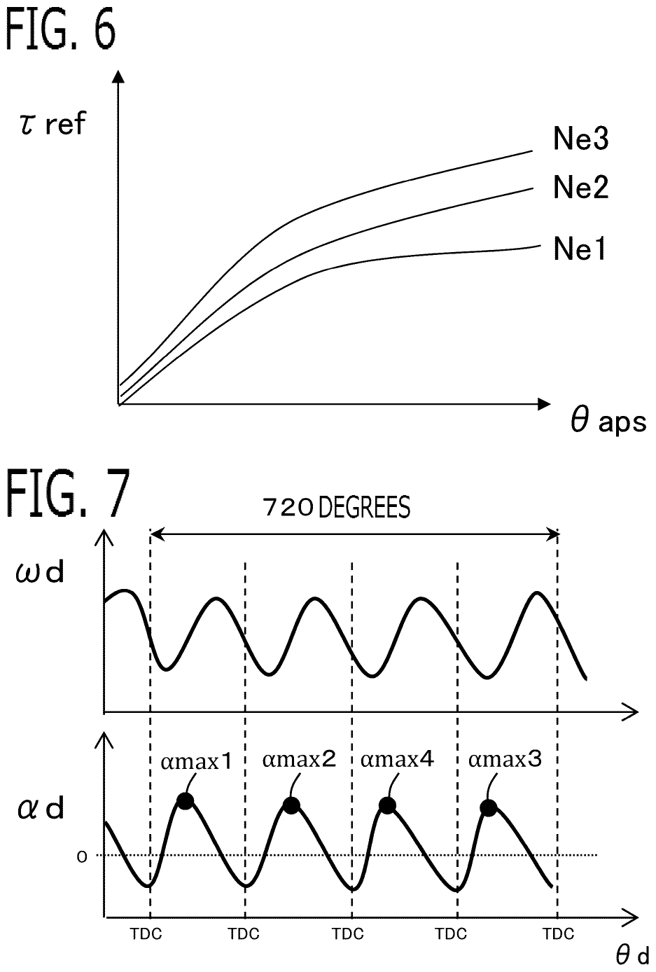

For example, by using a target torque setting data in which a relation between at least the accelerator opening degree θaps, the rotational speed Ne, and target torque τref is preliminarily set, the target torque calculation unit 52 calculates the target torque τref corresponding to the present accelerator opening degree θaps and the present rotational speed Ne. For example, as shown in FIG. 6, the target torque setting data is map data in which a relation between the accelerator opening degree θaps, the rotational speed Ne, and the target torque τref is preliminarily set. In FIG. 6, the relation between the accelerator opening degree θaps and the target torque τref is set for each of a plurality of rotational speeds Ne1, Ne2, and Ne3.

### 1-2-3. Estimation Torque Calculation Unit 53

The estimation torque calculation unit 53 calculates an estimation torque test which is an estimated torque of the crankshaft, based on the angular acceleration d.

In the present embodiment, as shown in FIG. 7, the estimation torque calculation unit 53 calculates the maximum value αmax of the angular acceleration αd during the combustion stroke, and calculates the estimation torque test based on the maximum value of angular acceleration αmax. According to this configuration, by calculating the maximum value αmax of the angular acceleration during the combustion stroke, the estimation torque test can be calculated using the maximum value αmax of the angular acceleration increased by combustion, and the maximum value of the momentary torque increased mainly by combustion can be calculated as the estimation torque test.

In the present embodiment, the internal combustion engine 1 is provided with the four combustion chambers 7 (cylinder 7). The estimation torque calculation unit 53 calculates the maximum values αmax1, αmax2, αmax3, and αmax4 of the angular acceleration during the combustion stroke for each of the four combustion chambers 7, and calculates the estimation torque test based on an average value αmaxave of the maximum values of the angular acceleration of the four combustion chambers, as shown in the next equation. The average value αmaxave is calculated whenever the crankshaft rotates twice.

$$\begin{matrix}[ Math . 3 ] & \\ {α}_{maxave} = \frac{{α}_{max 1} + {α}_{max 2} + {α}_{max 3} + {α}_{max 4}}{4} & ( 3 )\end{matrix}$$

According to this configuration, even if there is variation in combustion torque between cylinders, the maximum value of the average momentary combustion torque among cylinders can be calculated.

The estimation torque calculation unit 53 calculates the estimation torque test by multiplying an inertia moment Icrk to the angular acceleration αd (in this example, the average value among cylinders αmaxave of the maximum values of angular acceleration). The inertia moment Icrk is a total value of inertia moments of each rotation member which rotates integrally with the crankshaft, and is preliminarily set.

[Math. 4]

τₑₛₜ=αₘₐₓₐᵥₑ×I_{crk}+τ_{load} (4)

In the present embodiment, the estimation torque calculation unit 53 calculates the estimation torque τest by subtracting a load torque τload from a multiplication value of the angular acceleration αd and the inertia moment Icrk. The load torque τload is various load torques applied to the crankshaft from the outside of the internal combustion engine, and is usually a negative value. For example, a preliminarily set value is used for the load torque τload. Alternatively, since the load torque τload does not usually vary largely during the stroke period, the estimation torque calculation unit 53 may use a torque obtained by multiplying the angular acceleration αd at an angle in the vicinity of the top dead center (TDC) of the piston to the inertia moment Icrk, as the load torque τload. The angle in the vicinity of the top dead center (TDC) may be set to an angle within a range from 10 degrees before the top dead center to 10 degrees after the top dead center, for example, TDC. In the vicinity of the top dead center, since the connecting rod and the crank are aligned, and the shaft torque is not generated by the force of the cylinder pressure pushing the piston, the load torque τload can be calculated. According to this configuration, the load torque τload applied to the crankshaft from the outside of the internal combustion engine can be excluded, an increase amount of the momentary torque increased by combustion can be calculated, and the calculation accuracy of the estimation torque τest can be improved.

An average angular acceleration during the stroke period may be used for the calculation of the estimation torque τest.

### 1-2-4. Learning Value Calculation Unit 54

The learning value calculation unit 54 calculates a deviation Δτest between the estimation torque τest and a preliminarily set reference value of estimation torque τestref, as a torque error learning value Δτlrn.

According to this configuration, by comparing the estimation torque τest calculated based on the actually detected angular acceleration αd with the reference value of estimation torque τestref, a torque variation caused by the individual variation, the aging change (engine deterioration), or the like of the internal combustion engine 1 can be learned as the torque error learning value Δτlrn.

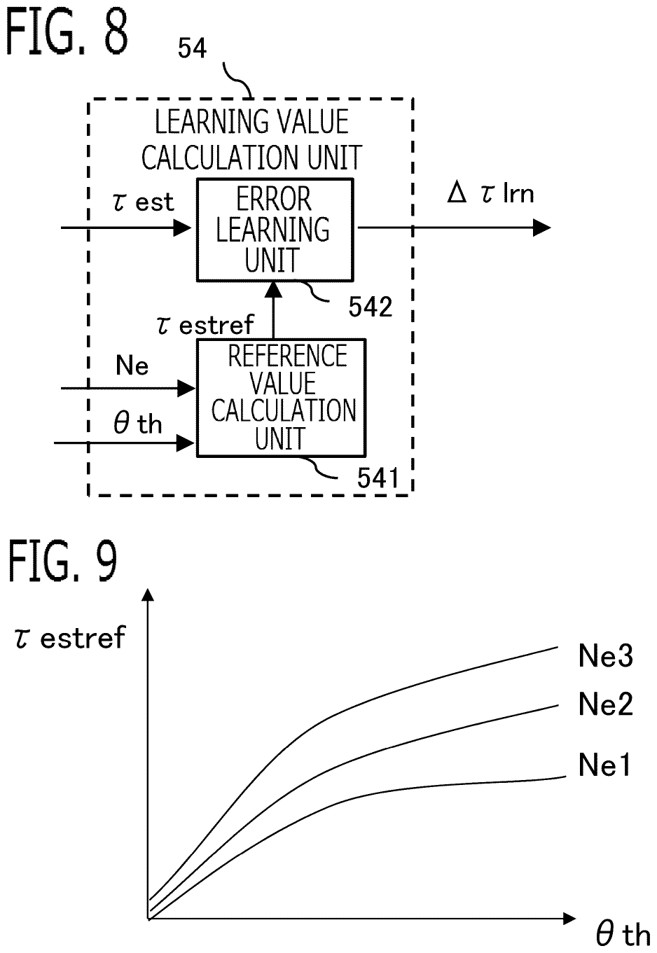

As shown in FIG. 8, the learning value calculation unit 54 is provided with a reference value calculation unit 541 and an error learning unit 542.

### <Reference Value Calculation Unit 541>

By using a torque characteristic data for reference value in which a relation between an operating state for reference value including at least one or more of the throttle opening degree θth, the cylinder internal intake air amount, the fuel injection amount, and the rotational speed Ne, and the reference value of estimation torque τestref is preliminarily set, the reference value calculation unit 541 calculates the reference value of estimation torque τestref corresponding to the present operating state for reference value.

Alternatively, the reference value calculation unit 541 may use the torque characteristic data for reference value in which a relation between the operating state for reference value including at least one or more of the target torque τref, the target throttle opening degree for reference value θthref0 calculated based on the target torque τref, and the rotational speed Ne, and the reference value of estimation torque τestref is preliminarily set.

In the present embodiment, since the reference value of estimation torque τestref is the maximum value or the increase amount of momentary torque which increased by combustion, it is a value different from the target torque τref which is the average output torque during the stroke period. Accordingly, in the torque characteristic data for reference value, a value corresponding to the maximum value or the increase amount of the momentary torque increased by combustion is set.

For example, a case where the throttle opening degree θth and the rotational speed Ne are used is explained as the operating state for reference value. As shown in FIG. 9, the torque characteristic data for reference value is a map data in which a relation between the throttle opening degree θth, the rotational speed Ne, and the reference value of estimation torque τestref is preliminarily set. The reference value calculation unit 541 calculates the reference value of estimation torque τestref corresponding to the present throttle opening degree θth and the present rotational speed Ne, by referring to the torque characteristic data for reference value. Herein, instead of the throttle opening degree θth, the cylinder internal intake air amount, the fuel injection amount, or the target torque τref may be used. That is, as the operating state for reference value, the rotational speed Ne, and a parameter correlated with output torque τ, such as the cylinder internal intake air amount, the fuel injection amount, or the target torque τref may be used.

As a different example, a case where the target throttle opening degree for reference value θthref0 calculated based on the target torque τref and the rotational speed Ne are used as the operating state for reference value is explained.

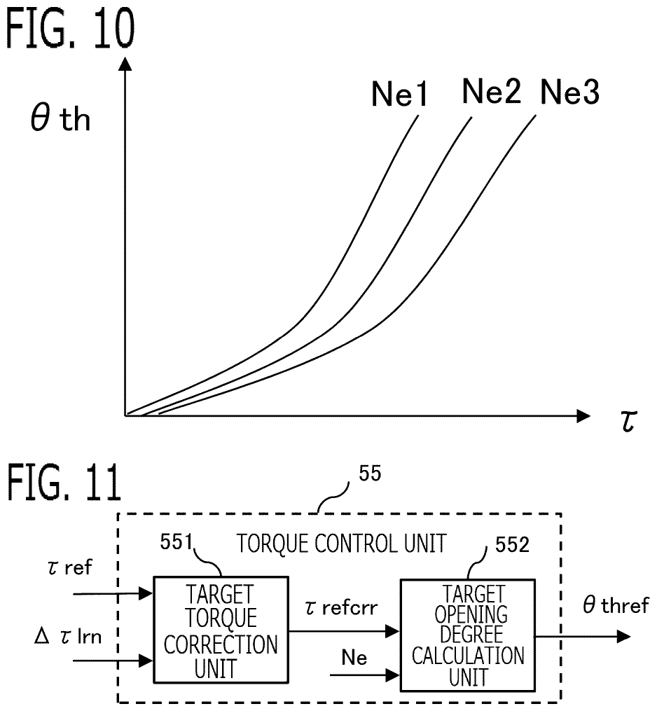

First, by using a throttle torque characteristic data in which a relation between at least the output torque τ of the internal combustion engine, the rotational speed Ne, and the throttle opening degree θth is preliminarily set, the reference value calculation unit 541 calculates the throttle opening degree θth corresponding to the target torque τref as the output torque τ and the present rotational speed Ne, as the target throttle opening degree for reference value θthref0. As shown in FIG. 10, the throttle torque characteristic data is map data in which a relation between the output torque τ, the rotational speed Ne, and the throttle opening degree θth is preliminarily set. The target torque τref is inputted into the output torque τ of the map data; the present rotational speed Ne is inputted into the rotational speed Ne of the map data; the throttle opening degree eth which is set in the map data corresponding to the output torque τ corresponding to target torque τref, and the rotational speed Ne corresponding to the present rotational speed Ne is calculated; and the calculated throttle opening degree θth is calculated as the target throttle opening degree for reference value θthref0.

In this case, in the torque characteristic data for reference value shown in FIG. 9, the throttle opening degree θth is changed to the target throttle opening degree for reference value θthref0. The reference value calculation unit 541 calculates the reference value of estimation torque τestref corresponding to the target throttle opening degree for reference value θthref0 and the present rotational speed Ne, by referring to the torque characteristic data for reference value. Herein, instead of the target throttle opening degree for reference value θthref0, the target value of cylinder internal intake air amount may be used.

As the operating state for reference value, various kinds of operating states of the internal combustion engines correlated with the output torque τ, such as, the EGR rate, the ignition timing, the opening and closing timing of the intake valve, and the opening and closing timing of the exhaust valve, may be used. The torque characteristic data for reference value may be a combination of a plurality of map data, or may be calculated from a mathematical model using a neural network.

### <Error Learning Unit 542>

The error learning unit 542 updates the torque error learning value Δτlrn, based on the deviation Δτest between the estimation torque τest and the reference value of estimation torque τestref.

The error learning unit 542 performs a statistical processing to the deviation Δτest, and updates the torque error learning value Δτlrn. For example, a low pass filter processing is performed as the statistical processing. The error learning unit 542 updates the torque error learning value Δτlrn using the next equation. Herein, (j) expresses a value calculated at the present update period, and (j−1) expresses a value calculated at the previous update period. Kflt is a filter gain set to a value smaller than one. In the present embodiment, the update period is set to a period when the crankshaft rotates twice.

[Math. 5]

Δτₑₛₜ(j)=τ_{estref}(j)−τₑₛₜ(j) (5)

Δτₗᵣₙ(j)=K_{flt}×Δτₑₛₜ(j)+(1−K_{flt})×Δτₗᵣₙ(j−1)

The torque error learning value Δτlrn may be provided for every region of the operating state which includes at least one or more of the throttle opening degree θth, the cylinder internal intake air amount, the fuel injection amount, and the rotational speed Ne, and updated. That is, the plurality of torque error learning value Δτlrn is provided corresponding to the plurality of regions, and updated.

As another example when the plurality of torque error learning values Δτlrn are calculated, a long-term torque error learning value and a short-term torque error learning value may be calculated by performing a long-term statistical processing and a short-term statistical processing. For example, the equation (5) is used for the calculation of the long-term torque error learning value, and the calculation of the short-term torque error learning value, a filter gain Kflt for the long-term torque error learning value is set to a value smaller than a filter gain Kflt for the short-term torque error learning value.

### 1-2-5. Torque Control Unit 55

By using a throttle torque characteristic data in which a relation between at least the output torque τ of the internal combustion engine, the rotational speed Ne, and the throttle opening degree θth is preliminarily set, the torque control unit 55 calculates the target throttle opening degree θthref such that the output torque τ of the internal combustion engine considering the torque error learning value Δτlrn approaches the target torque τref, based on the target torque τref of the internal combustion engine, the present rotational speed Ne, and the torque error learning value Δτlrn.

In the present embodiment, as shown in FIG. 11, the torque control unit 55 is provided with a target torque correction unit 551 and a target opening degree calculation unit 552. The target torque correction unit 551 calculates the target torque after correction τrefcrr by correcting the target torque τref based on the torque error learning value Δτlrn. Then, by referring to a throttle torque characteristic data in which a relation between at least the output torque τ of the internal combustion engine, the rotational speed Ne, and the throttle opening degree θth is preliminarily set, the target opening degree calculation unit 552 calculates the throttle opening degree θth corresponding to the target torque after correction τrefcrr as the output torque τ, and the present rotational speed Ne, as the target throttle opening degree θthref.

According to this configuration, by calculating the target torque after correction τrefcrr by correcting the target torque τref with the torque error learning value Δτlrn, an output torque error due to the deviation of the throttle torque characteristic data caused by the individual variation, the aging change (engine deterioration), or the like of the internal combustion engine 1 is compensated, and the output torque τ of the internal combustion engine can be brought close to the target torque τref with good accuracy.

### <Target Torque Correction Unit 551>

The target torque correction unit 551 calculates the target torque after correction τrefcrr by correcting the target torque τref based on the torque error learning value Δτlrn. For example, using the next equation, the target torque correction unit 551 calculates the target torque after correction τrefcrr.

[Math. 6]

τ_{refcrr}=τ_{ref}+Δτₗᵣₙ (6)

Alternatively, the target torque correction unit 551 may calculate a correction coefficient Kt based on an operating state for correction coefficient including at least one or more of the throttle opening degree θth, the cylinder internal intake air amount, the fuel injection amount, and the rotational speed Ne; and as shown in the next equation, may calculate a value obtained by adding a multiplication value of the torque error learning value Δτlrn and the correction coefficient Kt to the target torque τref, as the target torque after correction τrefcrr.

[Math. 7]

τ_{refcrr}=τ_{ref}+K_{τ}×Δτₗᵣₙ (7)

Since an influence degree of the torque error learning value Δτlrn on the estimation torque changes according to the operating state, the correction accuracy can be improved by multiplying the correction coefficient Kτ to the torque error learning value Δτlrn. A proportional coefficient of the average output torque during the stroke period with respect to the maximum value or the increase amount of the momentary torque increased by combustion changes according to the operating state. Accordingly, by calculating the correction coefficient Kτ based on the operating state for correction coefficient, and multiplying the correction coefficient Kτ to the torque error learning value Δτlrn, the correction accuracy can be improved.

For example, by referring to a correction coefficient setting data in which a relation between the operating state for correction coefficient and the correction coefficient Kτ is preliminarily set, the target torque correction unit 551 calculates the correction coefficient Kτ corresponding to the present operating state for correction coefficient. For example, the correction coefficient setting data is configured similarly to the torque characteristic data for reference value and the like, and for example, map data is used.

As another example, the target torque correction unit 551 may calculate a torque correction value τcom by feedback control, such as PI (Proportional-Integral) control, so that the torque error learning value Δτlrn approaches the target learning value Δτlrnref (usually 0) as time elapses; and may calculate the target torque after correction τrefcrr by correcting the target torque τref with the torque correction value τcom.

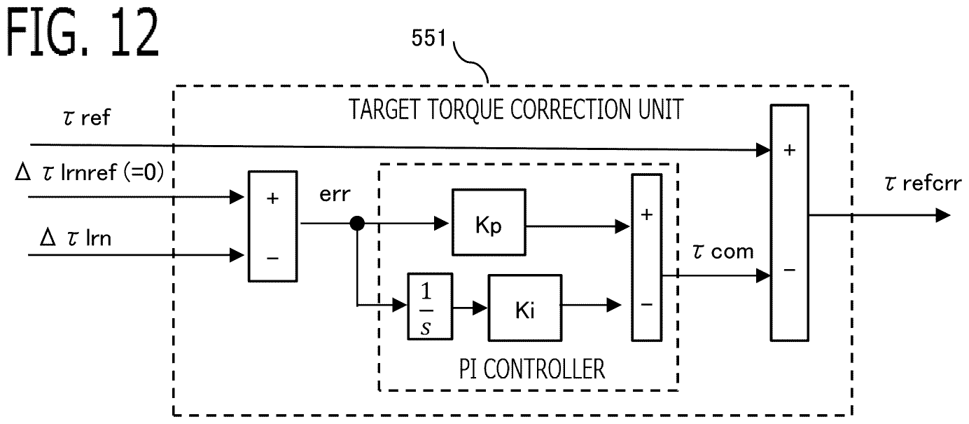

FIG. 12 shows an example using PI control in the target torque correction unit 551. “s” in figure is Laplace operator, and 1/s represents integration. The target torque correction unit 551 calculates a deviation err between the torque error learning value Δτlrn and the target learning value Δτlrnref (in this example, 0); and calculates the torque correction value τcom by performing PI control to the deviation err. Then, the target torque correction unit 551 calculates the target torque after correction τrefcrr by subtracting the torque correction value τcom from the target torque τref. The calculations of FIG. 12 can be expressed by the equation (8) and the equation (9). Herein, as previously mentioned, (j) expresses a value calculated at the present update period, and (j−1) expresses a value calculated at the previous update period. Kp and Ki are a proportional gain and an integral gains of PI controller, respectively.

$$\begin{matrix}[ Math . 8 ] & \\ err ( j ) = Δ {τ}_{lrnref} ( j ) - Δ {τ}_{lrn} ( j - 1 ) \\ {τ}_{com} ( j ) = {K}_{p} \times err ( j ) + {K}_{i} \times {\sum }_{k = 0}^{j} err ( k ) & ( 8 )\end{matrix}$$

$$\begin{matrix}[ Math . 9 ] & \\ {τ}_{refcrr} ( j ) = {τ}_{ref} ( j ) - {τ}_{com} ( j ) & ( 9 )\end{matrix}$$

According to this configuration, the torque correction value τcom for correcting the target torque τref is updated by feedback control, such as PI control, for every update period. Then, the torque error learning value Δτlrn can be converged to the target learning value Δτlrnref (in this example, 0) as time elapses. Accordingly, it is possible to obtain the output torque τ of the internal combustion engine 1 in which variation is suppressed.

<Target opening degree calculation unit 552>

By referring to the throttle torque characteristic data in which a relation between at least the output torque τ of the internal combustion engine, the rotational speed Ne, and the throttle opening degree θth is preliminarily set, the target opening degree calculation unit 552 calculates the throttle opening degree θth corresponding to the target torque after correction τrefcrr as the output torque τ, and the present rotational speed Ne, as the target throttle opening degree θthref.

The throttle torque characteristic data used herein is similar to the throttle torque characteristic data used in the reference value calculation unit 541, and the same data may be used. As shown in FIG. 10, the throttle torque characteristic data is map data in which a relation between the output torque τ, the rotational speed Ne, and the throttle opening degree θth is preliminarily set. The target torque after correction τrefcrr is inputted into the output torque τ of the map data; the present rotational speed Ne is inputted into the rotational speed Ne of the map data; the throttle opening degree eth which is set in the map data corresponding to the output torque τ corresponding to the target torque after correction τrefcrr, and the rotational speed Ne corresponding to the present rotational speed Ne is calculated; and the calculated throttle opening degree eth is calculated as the target throttle opening degree θthref.

### 1-2-6. Throttle Control Unit 56

The throttle control unit 56 controls the throttle opening degree θth based on the target throttle opening degree θthref. In the present embodiment, the throttle control unit 56 drives and controls the electric motor of the throttle valve 4 so that the throttle opening degree θth detected based on the output signal of the throttle position sensor 19 approaches the target throttle opening degree θthref.

### 2. Embodiment 2

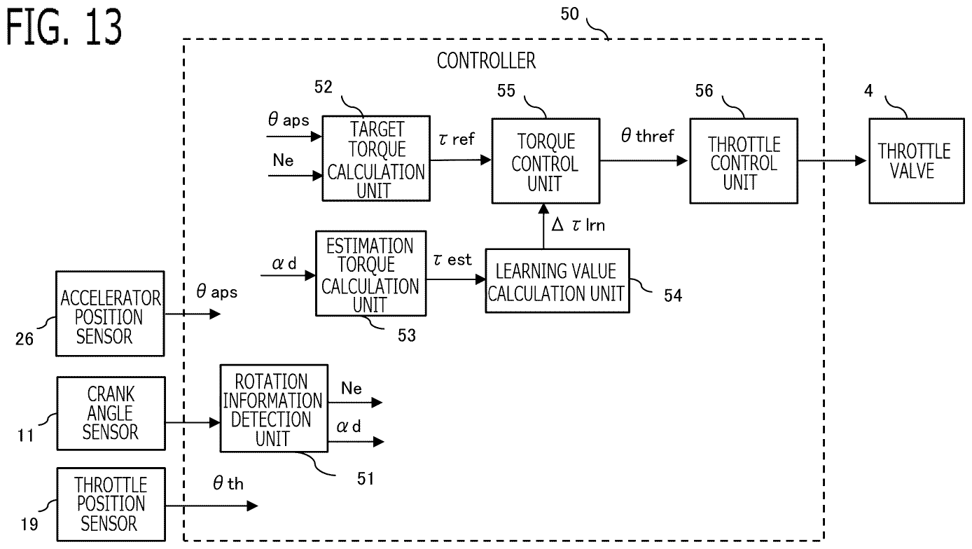

The controller 50 according to Embodiment 2 will be explained with reference to drawings. FIG. 13 is a functional block diagram showing operation of the controller 50 of the present embodiment. The explanation for constituent parts the same as those in Embodiment 1 will be omitted. The basic configuration of the controller 50 according to the present embodiment is the same as that of Embodiment 1. In the present embodiment, a part of processing of the torque control unit 55 is different from Embodiment 1.

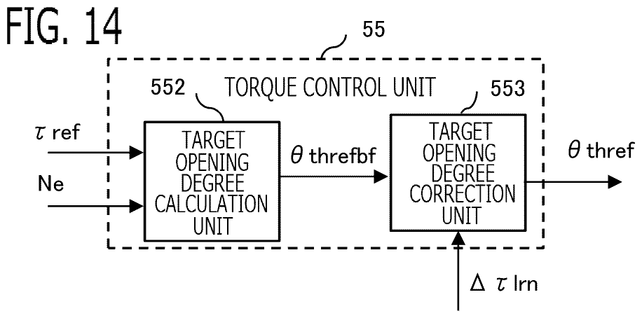

In the present embodiment, as shown in FIG. 14, the torque control unit 55 is provided with the target opening degree calculation unit 552 and the target opening degree correction unit 553.

In the present embodiment, by referring the throttle torque characteristic data in which a relation between at least the output torque τ of the internal combustion engine, the rotational speed Ne, and the throttle opening degree θth is preliminarily set, the target opening degree calculation unit 552 calculates the throttle opening degree θth corresponding to the target torque τref as the output torque τ, and the present rotational speed Ne, as a target throttle opening degree before correction θthrefbf.

The throttle torque characteristic data used herein is similar to the throttle torque characteristic data used in the reference value calculation unit 541 of Embodiment 1, and the same data may be used. As shown in FIG. 10, the throttle torque characteristic data is map data in which a relation between the output torque τ, the rotational speed Ne, and the throttle opening degree eth is preliminarily set. The target torque τref is inputted into the output torque τ of the map data; the present rotational speed Ne is inputted into the rotational speed Ne of the map data; the throttle opening degree eth which is set in the map data corresponding to the output torque τ corresponding to the target torque τref, and the rotational speed Ne corresponding to the present rotational speed Ne is calculated; and the calculated throttle opening degree θth is calculated as the target throttle opening degree before correction θthrefbf.

The target opening degree correction unit 553 calculates the target throttle opening degree θthref by correcting the target throttle opening degree before correction θthref based on the torque error learning value Δτlrn.

According to this configuration, by calculating the target throttle opening degree θthref by correcting the target throttle opening degree before correction θthref corresponding to the target torque τref with the torque error learning value Δτlrn, an output torque error due to the deviation of the throttle torque characteristic data caused by the individual variation, the aging change, or the like of the internal combustion engine 1 is compensated, and the output torque τ of the internal combustion engine can be brought close to the target torque τref with good accuracy.

For example, the target opening degree correction unit 553 calculates a conversion coefficient Kcnv based on an operating state for conversion coefficient including at least one or more of the throttle opening degree θth, the cylinder internal intake air amount, the fuel injection amount, and the rotational speed Ne; and as shown in the next equation, calculates a value obtained by adding a multiplication value of the torque error learning value Δτlrn and the conversion coefficient Kcnv to the target throttle opening degree before correction θthrefbf, as the target throttle opening degree θthref. The conversion coefficient Kcnv is a conversion coefficient for converting a torque deviation into a throttle opening degree deviation causing the torque deviation.

[Math. 10]

θ_{thref}=θ_{threfbf}+K_{cnv}×Δτₗᵣₙ (10)

For example, by referring to a conversion coefficient setting data in which a relation between the operating state for conversion coefficient, and the conversion coefficient Kcnv is preliminarily set, the target opening degree correction unit 553 calculates the conversion coefficient Kcnv corresponding to the present operating state for conversion coefficient. For example, the conversion coefficient setting data is configured similarly to the torque characteristic data for reference value and the like, and for example, map data is used.

Alternatively, the target opening degree correction unit 553 may calculate a throttle opening degree correction value θthcom by feedback control, such as PI (Proportional-Integral) control, so that the torque error learning value Δτlrn approaches the target learning value Δτlrnref (usually 0) as time elapses; and may calculate the target throttle opening degree θthref by correcting the target throttle opening degree before correction θthrefbf with the throttle opening degree correction value θthcom.

For example, as shown in the equation (11) and the equation (12), the target opening degree correction unit 553 calculates a deviation err between the torque error learning value Δτlrn and the target learning value Δτlrnref (in this example, 0); and calculates the throttle opening degree correction value θthcom by performing PI control to the deviation err. Then, the target opening degree correction unit 553 calculates the target throttle opening degree θthref by subtracting the throttle opening degree correction value θthcom from the target throttle opening degree before correction θthrefbf. Herein, as previously mentioned, (j) expresses a value calculated at the present update period, and (j−1) expresses a value calculated at the previous update period. Kp2 and Ki2 are a proportional gain and an integral gains of PI controller, respectively.

$$\begin{matrix}[ Math . 11 ] & \\ err ( j ) = {Δτ}_{lrnref} ( j ) - {Δτ}_{lrn} ( j - 1 ) \\ {θ}_{thcom} ( j ) = {K}_{p 2} \times err ( j ) + {K}_{i 2} \times {\sum }_{k = 0}^{j} err ( k ) & ( 11 )\end{matrix}$$

$$\begin{matrix}[ Math . 12 ] & \\ {θ}_{thref} ( j ) = {θ}_{threfbf} ( j ) - {θ}_{thcom} ( j ) & ( 12 )\end{matrix}$$

According to this configuration, the throttle opening degree correction value θthcom for correcting the target throttle opening degree before correction θthrefbf is updated by feedback control, such as PI control, for every update period. Then, the torque error learning value Δτlrn can be converged to the target learning value Δτlrnref (in this example, 0) as time elapses. Accordingly, it is possible to obtain the output torque τ of the internal combustion engine 1 in which variation is suppressed.

### 3. Embodiment 3

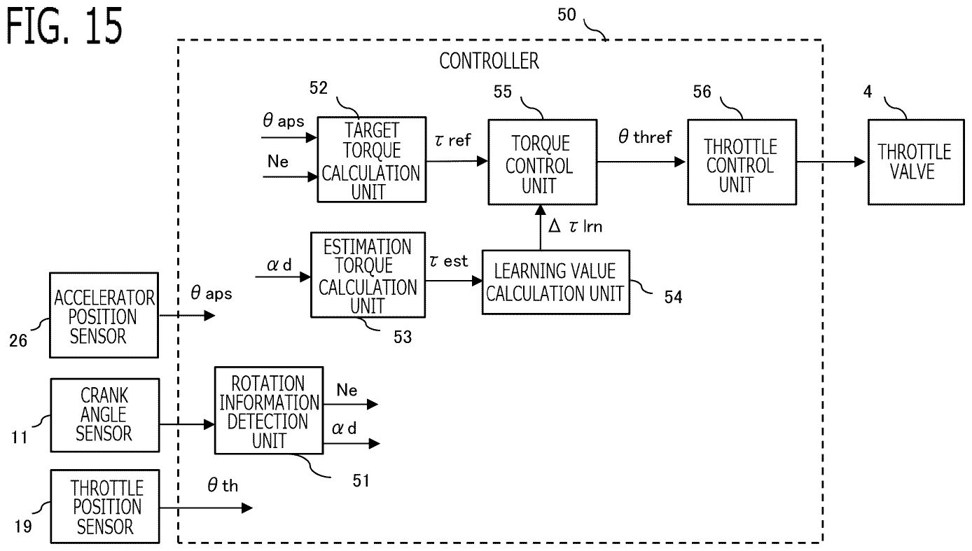

The controller 50 according to Embodiment 3 will be explained with reference to drawings. FIG. 15 is a functional block diagram showing operation of the controller 50 of the present embodiment. The explanation for constituent parts the same as that of Embodiment 1 or 2 will be omitted. The basic configuration of the controller 50 according to the present embodiment is the same as that of Embodiment 1 or 2. In the present embodiment, a part of processing of the learning value calculation unit 54 is different from Embodiment 1 or 2.

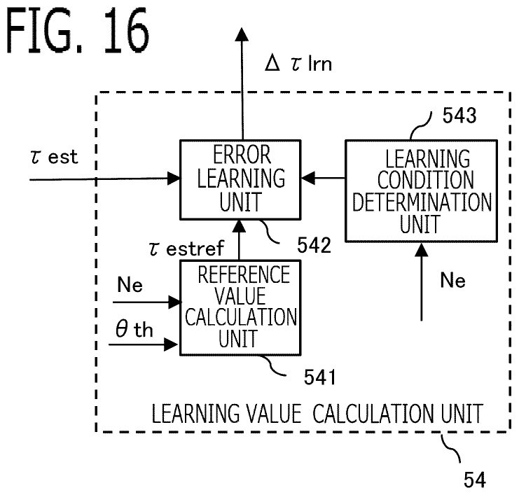

In the present embodiment, as shown in FIG. 16, the learning value calculation unit 54 is provided with a learning condition determination 543 in addition to the reference value calculation unit 541 and the error learning unit 542.

The learning condition determination unit 543 determines whether or not a learning condition is established based on an operating state for learning determination including at least one or more of the throttle opening degree θth, the cylinder internal intake air amount, the fuel injection amount, and the rotational speed Ne. The error learning unit 542 updates the torque error learning value Δτlrn based on the deviation Δτest, when the learning condition is established.

The learning condition determination unit 543 may use one or more of an environmental state, such as the intake-air temperature, the cooling water temperature, and the atmospheric pressure, and an operating state of the power transfer mechanism, such as the gear and the clutch, to which the crankshaft of the internal combustion engine 1 is connected, as a condition for determining whether or not the learning condition is established.

According to this configuration, the learning accuracy can be improved, by learning when the preliminarily set learning condition is established.

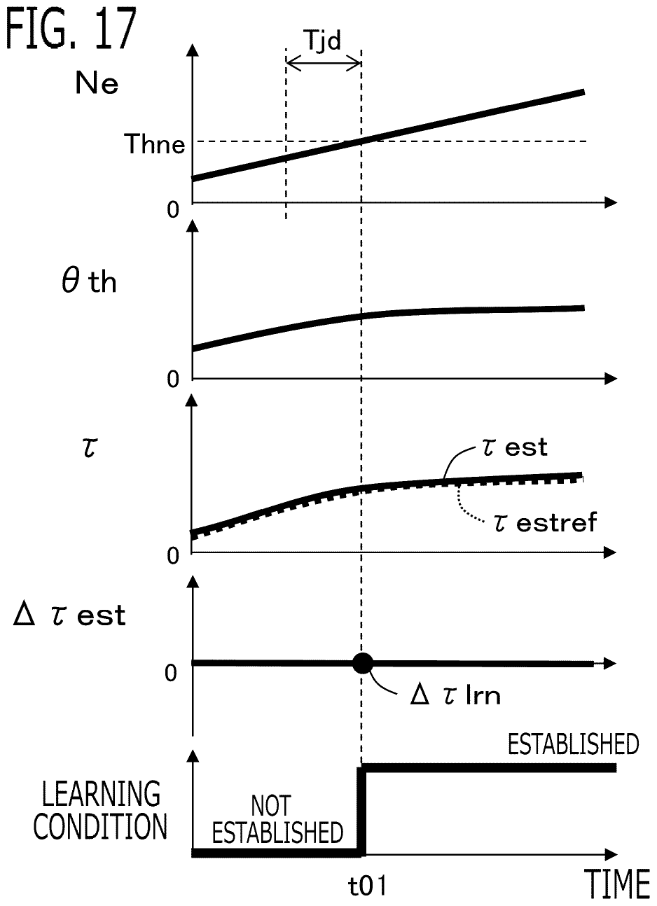

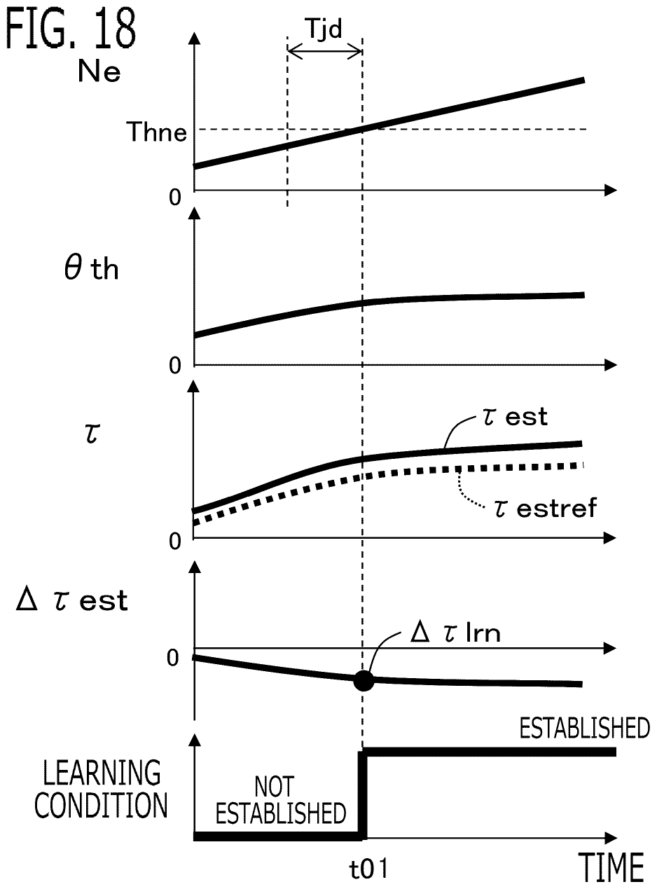

In the present embodiment, as shown in FIG. 17 and FIG. 18, the learning condition determination unit 543 determines that the learning condition is established, when the rotational speed Ne passes a preliminarily set determination rotational speed Thne during the increase in the rotational speed Ne.

The state where acceleration and deceleration of the rotational speed Ne are performed is a transient state where the torque of the internal combustion engine is increasing or decreasing. Accordingly, if the learning is performed in this transient state, it easily causes a decrease in the learning accuracy. In the state where the rotational speed Ne is increasing continuously, the torque increases and decreases little and is stable. The learning accuracy can be improved. Especially, in the case of two-wheel vehicles, the output of the internal combustion engine is small and the inertia is low compared with four-wheel vehicles. The learning accuracy is reduced easily due to variation factors, but the decrease in the learning accuracy can be suppressed by the above configuration.

For example, the learning condition determination unit 543 determines that the learning condition is established, when the rotational speed Ne is increasing continuously during a determination period Tjd and the rotational speed Ne passes the determination rotational speed Thne.

By setting the determination period Tjd, the state where the torque increases and decreases little and is stable can be determined with better accuracy, and the learning accuracy can be improved.

Furthermore, the learning condition determination unit 543 may determine that the learning condition is established, when the rotational speed Ne is increasing continuously within a preliminarily set range of an increase rate during the determination period Tjd, and the rotational speed Ne passes the determination rotational speed Thne.

By setting the range of the increase rate of the rotational speed Ne, the state where the torque increases and decreases little and is stable can be determined with further better accuracy, and the learning accuracy can be improved.

As the conditions for determining that the learning condition is established, in addition to the condition to the rotational speed Ne, the learning condition determination unit 543 may add a condition that the cooling water temperature is greater than or equal to a preliminarily set temperature.

According to this configuration, a case where the inside of the internal combustion engine 1 does not reach an appropriate temperature immediately after the cold start of the internal combustion engine 1 or the like is determined by the cooling water temperature. When the cooling water temperature is less than the preliminarily set temperature, it is assumed that the torque output characteristic is different from that of the reference operating state, the learning condition is not established and the learning is not performed. In this way, by determining whether or not the learning condition is established based on the environmental state, such as the cooling water temperature, when the operating state at the time of learning is different from the reference operating state, the learning condition is not established and the learning is not performed. Accordingly, by limiting the operating state as the learning condition, the variation in the learning value for every learning can be suppressed.

The behavior at learning will be explained using FIG. 17 and FIG. 18. First, FIG. 17 will be explained. In FIG. 17, the internal combustion engine has no individual variation and no aging change, the estimation torque τest coincides with the reference value of estimation torque τestref, and the deviation Δτest is close to zero. The throttle opening degree eth increases, the torque increases, and the rotational speed Ne is increasing continuously. During the increase in the rotational speed Ne, at the time t01, the rotational speed Ne passes the determination rotational speed Thne, and the learning condition is established. The deviation Δτest when the learning condition is established is learned as the torque error learning value Δτlrn.

Next, FIG. 18 will be explained. In FIG. 18, the internal combustion engine has the individual variation and the aging change, and the estimation torque τest exceeds the reference value of estimation torque τestref, and the deviation Δτest is smaller than zero. The throttle opening degree θth increases, the torque increases, and the rotational speed Ne is increasing continuously. During the increase in the rotational speed Ne, at the time t01, the rotational speed Ne passes the determination rotational speed Thne, and the learning condition is established. The deviation Δτest when the learning condition is established is learned as the torque error learning value Δτlrn.

An average value of the plurality of deviations Δτest when the learning condition is established plural times may be learned as the torque error learning value Δτlrn.

Before the internal combustion engine 1 is stopped and the processing operation is ended, the controller 50 stores the torque error learning value Δτlrn of one or more times in the nonvolatile storage apparatus, such as EEPROM. Then, when starting again, the controller 50 reads the torque error learning value Δτlrn stored in the storage apparatus. Accordingly, even after the restart, the controller 50 can calculate the target throttle opening degree θthref using the torque error learning value Δτlrn learned previously. Accordingly, an output torque error due to the deviation of the throttle torque characteristic data caused by the individual variation, the aging change, or the like of the internal combustion engine 1 is compensated, and the output torque τ of the internal combustion engine can be brought close to the target torque τref with good accuracy.

### 4. Embodiment 4

The controller 50 according to Embodiment 4 will be explained with reference to drawings. The explanation for constituent parts the same as that of Embodiment 1, 2, or 3 will be omitted.

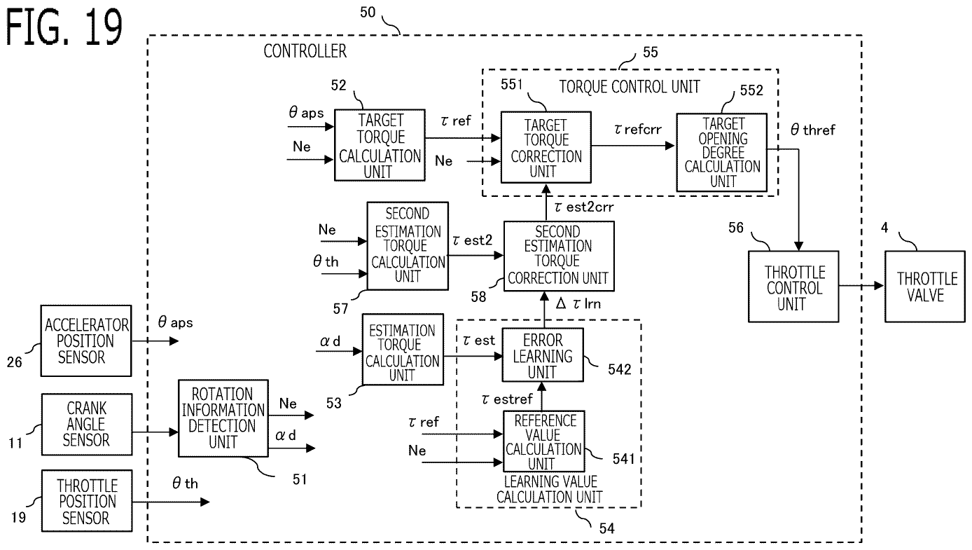

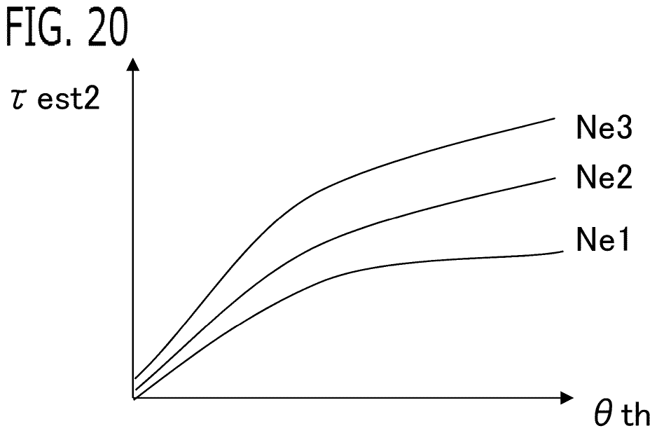

In the present embodiment, as shown in FIG. 19, the controller 50 is provided with a second estimation torque calculation unit 57 and a second estimation torque correction unit 58, in addition to the processing units of the rotation information detection unit 51, the target torque calculation unit 52, the estimation torque calculation unit 53, the learning value calculation unit 54, the torque control unit 55, and the throttle control unit 56. And, in the present embodiment, a part of processing of the torque control unit 55 is different from Embodiment 1, 2 or 3. Similar to Embodiment 1, the respective processing units 51 to 58 of the controller 50 are realized by processing circuits provided in the controller 50.

By using a torque characteristic data for second estimation torque in which a relation between an operating state for torque characteristic data including at least one or more of the throttle opening degree θth, the cylinder internal intake air amount, the fuel injection amount, and the rotational speed Ne, and a second estimation torque τest2 as the output torque τ of the internal combustion engine is preliminarily set, the second estimation torque calculation unit 57 calculates the second estimation torque τest2 corresponding to the present operating state for torque characteristic data. Herein, the second estimation torque τest2 is a torque outputted to the outside of the internal combustion engine from the crankshaft, is an average output torque during the stroke period, and corresponds to the target torque τref. Accordingly, the torque characteristic data for second estimation torque treats data different from the torque characteristic data for reference value used in the learning value calculation unit 54.

For example, a case where the throttle opening degree θth and the rotational speed Ne are used as the operating state for torque characteristic data will be explained. As shown in FIG. 20, the torque characteristic data for second estimation torque is map data in which a relation between the throttle opening degree θth, the rotational speed Ne, and the second estimation torque τest2 is preliminarily set. The second estimation torque calculation unit 57 calculates the second estimation torque τest2 corresponding to the present throttle opening degree θth and the present rotational speed Ne, by referring to the torque characteristic data for second estimation torque. Herein, instead of the throttle opening degree θth, the cylinder internal intake air amount, the fuel injection amount, or the target torque τref may be used. That is, as the operating state for torque characteristic data, the rotational speed Ne, and a parameter correlated with output torque τ, such as the cylinder internal intake air amount, the fuel injection amount, or the target torque τref may be used.

As the operating state for torque characteristic data, various operating states of internal combustion engine correlated with the output torque τ, for example, the EGR rate, the ignition timing, the opening and closing timing of the intake valve, and the opening and closing timing of the exhaust valve may be used. The torque characteristic data for second estimation torque may be a combination of a plurality of map data, or may be calculated from a mathematical model using a neural network.

The second estimation torque correction unit 58 calculates a second estimation torque after correction τest2crr by correcting the second estimation torque τest2 with the torque error learning value Δτlrn. For example, the second estimation torque correction unit 58 calculates the second estimation torque after correction τest2crr using the next equation.

[Math. 13]

τ_{est2crr}=τₑₛₜ₂+Δτₗᵣₙ (13)

According to this configuration, the second estimation torque τest2 calculated by referring to the preliminarily set torque characteristic data for second estimation torque is corrected by the torque error learning value Δτlrn which learned the torque variation caused by the individual variation, the aging change (engine deterioration), or the like of the internal combustion engine 1, and the second estimation torque after correction τest2crr is calculated. Accordingly, the accurate torque estimation value in which the torque variation caused by the individual variation, the aging change (engine deterioration), or the like of the internal combustion engine 1 was reflected can be calculated.

Alternatively, the second estimation torque correction unit 58 may calculate a correction coefficient Kτest based on the operating state for correction coefficient including at least one or more of the throttle opening degree θth, the cylinder internal intake air amount, the fuel injection amount, and the rotational speed Ne; and may calculate a value obtained by adding a multiplication value of the torque error learning value Δτlrn and the correction coefficient Kτest to the second estimation torque τest2, as the second estimation torque after correction τest2crr, as shown in the next equation.

[Math. 14]

τ_{est2crr}=τₑₛₜ₂+K_{τest}×Δτₗᵣₙ (14)

According to this configuration, since an influence degree of the torque error learning value Δτlrn on the estimation torque changes according to the operating state, the correction accuracy can be improved by multiplying the correction coefficient Kτest to the torque error learning value Δτlrn. A proportional coefficient of the average output torque τ during the stroke period with respect to the maximum value or the increase amount of the momentary torque increased by combustion changes according to the operating state. Accordingly, by calculating the correction coefficient Kτest based on the operating state for correction coefficient, and multiplying the correction coefficient Kτest to the torque error learning value Δτlrn, the correction accuracy can be improved.

By referring to a correction coefficient setting data in which a relation between the operating state for correction coefficient and the correction coefficient Kτest is preliminarily set, the second estimation torque correction unit 58 calculates the correction coefficient Kτest corresponding to the present operating state for correction coefficient. The correction coefficient setting data is configured similarly to the torque characteristic data for reference value and the like, and for example, map data is used.

By using the throttle torque characteristic data in which a relation between at least the output torque τ of the internal combustion engine, the rotational speed Ne, and the throttle opening degree θth is preliminarily set, the torque control unit 55 calculates the target throttle opening degree θthref such that the second estimation torque after correction τest2crr approaches the target torque τref, based on the target torque τref of the internal combustion engine, the present rotational speed Ne, and the second estimation torque after correction τest2crr.

According to this configuration, the second estimation torque after correction τest2crr is an accurate torque estimation value in which the torque variation caused by the individual variation, the aging change, or the like of the internal combustion engine 1 was reflected; and the target throttle opening degree θthref is calculated such that the second estimation torque after correction τest2crr approaches the target torque τref. Accordingly, an output torque error due to the deviation of the throttle torque characteristic data caused by the individual variation, the aging change, or the like of the internal combustion engine 1 is compensated, and the output torque τ of the internal combustion engine can be brought close to the target torque τref with good accuracy. As shown in FIG. 19, the torque control unit 55 is provided with the target torque correction unit 551 and the target opening degree calculation unit 552.

The target torque correction unit 551 calculates the target torque after correction τrefcrr by feedback control, such as PI (Proportional-Integral) control, so that the second estimation torque after correction τest2crr approaches the target torque τref as time elapses.

As shown in the equation (15) and the equation (16), the target torque correction unit 551 calculates a torque deviation τerr between the second estimation torque after correction τest2crr and the target torque τref; and calculates a torque correction value τcom2 by performing PI control to the torque deviation terr. Then, the target torque correction unit 551 calculates the target torque after correction τrefcrr by subtracting the torque correction value τcom2 from the target torque τref. Herein, as previously mentioned, (j) expresses a value calculated at the present update period, and (j−1) expresses a value calculated at the previous update period. Kp3 and Ki3 are a proportional gain and an integral gains of PI controller, respectively.

$$\begin{matrix}[ Math . 15 ] & \\ τ err ( j ) = {τ}_{ref} ( j ) - {τ}_{est 2 crr} ( j ) \\ {τ}_{com 2} ( j ) = {K}_{p 3} \times τ err ( j ) + {K}_{i 3} \times {\sum }_{k = 0}^{j} τ err ( k ) & ( 15 )\end{matrix}$$

$$\begin{matrix}[ Math . 16 ] & \\ {τ}_{refcrr} ( j ) = {τ}_{ref} ( j ) - {τ}_{com 2} ( j ) & ( 16 )\end{matrix}$$

According to this configuration, the torque correction value τcom for correcting the target torque τref is updated by feedback control, such as PI control, for every update period. Then, the second estimation torque after correction τest2crr can be converged to the target torque τref as time elapses. Accordingly, it is possible to obtain the output torque τ of the internal combustion engine 1 in which variation is suppressed.

By referring the throttle torque characteristic data in which a relation between at least the output torque τ of the internal combustion engine, the rotational speed Ne, and the throttle opening degree θth is preliminarily set, the target opening degree calculation unit 552 calculates the throttle opening degree θth corresponding to the target torque after correction τrefcrr as the output torque τ, and the present rotational speed Ne, as the target throttle opening degree θthref. Since the configuration of the target opening degree calculation unit 552 is similar to Embodiment 1, explanation is omitted

In each of above embodiments, there has been explained the case where, by using the torque error learning value Δτlrn, the second estimation torque after correction τest2crr, or the like, the controller 50 calculates the target throttle opening degree θthref so that the output torque τ of the internal combustion engine 1 approaches the target torque τref. As anther example, the controller 50 may transmit the torque error learning value Δτlrn, the second estimation torque after correction τest2crr, or the like to an external controller, such as a vehicle controller and a motor controller, and may reflect it to a torque control of the external controller.

In each of above Embodiments, there has been explained the case where the four-cylinder internal combustion engine with four cylinders is used. However, the internal combustion engine with any number of cylinders (for example, one-cylinder, two-cylinder, three-cylinder, six-cylinder) may be used.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

1: Internal Combustion Engine, 2: Crankshaft, 7: Combustion Chamber, 50: Controller for Internal Combustion Engine, 51: Rotation Information Detection Unit, 52: Target Torque Calculation Unit, 53: Estimation Torque Calculation Unit, 54: Learning Value Calculation Unit, 55: Torque Control Unit, 56: Throttle Control Unit, 57: Second Estimation Torque Calculation Unit, 58: Second Estimation Torque Correction Unit, Ne: Rotational speed, Thne: Determination Rotational Speed, Tjd: Determination Period, err: Deviation, Δτlrn: Torque Error Learning Value, Δτlrnref: Target Learning Value, αd: Angular Acceleration, αmax: Maximum Value of Angular Acceleration, αmaxave: Average Value of Maximum Value, θth: Throttle Opening Degree, θthcom: Throttle Opening Degree Correction Value, θthref: Target Throttle Opening Degree, θthref0: Target Throttle Opening Degree for Reference Value, θthrefbf: Target Throttle Opening Degree before Correction, τ: Output Torque, τcom: Torque Correction Value, τcom2: Torque Correction Value, τest: Estimation Torque, τest2: Second Estimation Torque, τest2crr: Second Estimation Torque after Correction, τestref: Reference Value of Estimation Torque, τref: Target Torque, τrefcrr: Target Torque after Correction

1. A controller for an internal combustion engine, comprising at least one processor configured to implement:
a rotation information detector that detects a rotational speed and an angular acceleration of a crankshaft of the internal combustion engine;
an estimation torque calculator that calculates an estimation torque which is an estimated torque of the crankshaft, based on the angular acceleration;
a learning value calculator that learns a deviation between the estimation torque and a preliminarily set reference value of estimation torque, as a torque error learning value;
a torque controller that, by using a throttle torque characteristic data in which a relation between at least an output torque of the internal combustion engine, the rotational speed, and a throttle opening degree of the internal combustion engine is preliminarily set, calculates a target throttle opening degree such that the output torque considering the torque error learning value approaches the target torque, based on a target torque of the internal combustion engine, the present rotational speed, and the torque error learning value; and
a throttle controller that controls the throttle opening degree, based on the target throttle opening degree.

2. The controller for the internal combustion engine according to claim 1,
wherein the torque controller calculates a target torque after correction by correcting the target torque based on the torque error learning value; and, by referring to the throttle torque characteristic data, calculates the throttle opening degree corresponding to the target torque after correction as the output torque, and the present rotational speed, as the target throttle opening degree.

3. The controller for the internal combustion engine according to claim 2,
wherein the torque controller calculates a torque correction value by a feedback control so that the torque error learning value approaches a target learning value, and calculates the target torque after correction by correcting the target torque with the torque correction value.

4. The controller for the internal combustion engine according to claim 1,
wherein the torque controller, by referring the throttle torque characteristic data, calculates the throttle opening degree corresponding to the target torque as the output torque, and the present rotational speed, as a target throttle opening degree before correction; and calculates the target throttle opening degree by correcting the target throttle opening degree before correction based on the torque error learning value.

5. The controller for the internal combustion engine according to claim 4,
wherein the torque controller calculates a throttle opening degree correction value by a feedback control so that the torque error learning value approaches a target learning value; and calculates the target throttle opening degree by correcting the target throttle opening degree before correction with the throttle opening degree correction value.

6. A controller for an internal combustion engine, comprising at least one processor configured to implement:
a rotation information detector that detects a rotational speed and an angular acceleration of a crankshaft of the internal combustion engine;
an estimation torque calculator that calculates an estimation torque which is an estimated torque of the crankshaft, based on the angular acceleration;
a learning value calculator that learns a deviation between the estimation torque and a preliminarily set reference value of estimation torque, as a torque error learning value;
a second estimation torque calculator that, by referring to a torque characteristic data for second estimation torque in which a relation between an operating state for torque characteristic data including at least one or more of a throttle opening degree of the internal combustion engine, a cylinder internal intake air amount, a fuel injection amount, and the rotational speed, and a second estimation torque as an output torque of the internal combustion engine is preliminarily set, calculates a second estimation torque corresponding to the present operating state for torque characteristic data;
a second estimation torque corrector that calculates a second estimation torque after correction by correcting the second estimation torque with the torque error learning value;
a torque controller that, by using a throttle torque characteristic data in which a relation between at least the output torque, the rotational speed, and the throttle opening degree is preliminarily set, calculates a target throttle opening degree such that the second estimation torque after correction approaches a target torque of the internal combustion engine, based on the target torque, the present rotational speed, and the second estimation torque after correction; and
a throttle controller that controls the throttle opening degree, based on the target throttle opening degree.

7. The controller for the internal combustion engine according to claim 6,
wherein the torque controller calculates a torque correction value by a feedback control so that the second estimation torque after correction approaches the target torque;
calculates a target torque after correction by correcting the target torque with the torque correction value; and
by referring to the throttle torque characteristic data, calculates the throttle opening degree corresponding to the target torque after correction as the output torque, and the present rotational speed, as the target throttle opening degree.

8. The controller for the internal combustion engine according to claim 1,
wherein the estimation torque calculator calculates a maximum value of the angular acceleration during a combustion stroke, and calculates the estimation torque based on the maximum value.

9. The controller for the internal combustion engine according to claim 1,
wherein the internal combustion engine has a plurality of combustion chambers, and wherein the estimation torque calculator calculates a maximum value of the angular acceleration during a combustion stroke, for each of the plurality of combustion chambers; and
calculates the estimation torque based on an average value of the maximum values of the plurality of combustion chambers.

10. The controller for the internal combustion engine according to claim 1,
wherein, by using a torque characteristic data for reference value in which a relation between an operating state for reference value including at least one or more of the target torque, a target throttle opening degree for reference value calculated based on the target torque, the throttle opening degree, a cylinder internal intake air amount, a fuel injection amount, and the rotational speed, and the reference value of estimation torque is preliminarily set, the learning value calculator calculates the reference value of estimation torque corresponding to the present operating state for reference value.

11. The controller for the internal combustion engine according to claim 1,
wherein the learning value calculator stores the torque error learning value in a storage apparatus; and reads the torque error learning value stored in the storage apparatus at a time of restarting after stopping the controller for the internal combustion engine.

12. The controller for the internal combustion engine according to claim 1,
wherein, when the rotational speed passes a preliminarily set determination rotational speed during an increase in the rotational speed, the learning value calculator determines that a learning condition is established, and updates the torque error learning value based on the deviation.

13. The controller for the internal combustion engine according to claim 12,
wherein, when the rotational speed continuously increases during a determination period and the rotational speed passes a determination rotational speed, the learning value calculator determines that the learning condition is established.

14. The controller for the internal combustion engine according to claim 6,
wherein the estimation torque calculator calculates a maximum value of the angular acceleration during a combustion stroke, and calculates the estimation torque based on the maximum value.

15. The controller for the internal combustion engine according to claim 6,
wherein the internal combustion engine has a plurality of combustion chambers, and
wherein the estimation torque calculator calculates a maximum value of the angular acceleration during a combustion stroke, for each of the plurality of combustion chambers; and
calculates the estimation torque based on an average value of the maximum values of the plurality of combustion chambers.

16. The controller for the internal combustion engine according to claim 6,
wherein, by using a torque characteristic data for reference value in which a relation between an operating state for reference value including at least one or more of the target torque, a target throttle opening degree for reference value calculated based on the target torque, the throttle opening degree, a cylinder internal intake air amount, a fuel injection amount, and the rotational speed, and the reference value of estimation torque is preliminarily set, the learning value calculator calculates the reference value of estimation torque corresponding to the present operating state for reference value.

17. The controller for the internal combustion engine according to claim 6,
wherein the learning value calculator stores the torque error learning value in a storage apparatus; and reads the torque error learning value stored in the storage apparatus at a time of restarting after stopping the controller for the internal combustion engine.

18. The controller for the internal combustion engine according to claim 6,
wherein, when the rotational speed passes a preliminarily set determination rotational speed during an increase in the rotational speed, the learning value calculator determines that a learning condition is established, and updates the torque error learning value based on the deviation.

19. The controller for the internal combustion engine according to claim 18,
wherein, when the rotational speed continuously increases during a determination period and the rotational speed passes a determination rotational speed, the learning value calculator determines that the learning condition is established.
